(19) United States
(12) Patent Application Publication
(10) Pub. No.: US 2026/0233993 A1
(43) Pub. Date: Aug. 13, 2026

(54) SYSTEM AND METHOD FOR PRODUCING SYNGAS

(71) Applicant: SHELL USA, INC., Houston, TX (US)

(72) Inventors: Govert Gerardus Pieter VAN DER PLOEG, Amsterdam (NL); Arian NIJMEIJER, Amsterdam (NL)

(21) Appl. No.: 19/155,928

(22) PCT Filed: Feb. 21, 2024
(86) PCT No.: PCT/EP2024/054409

§ 371 Date: Aug. 12, 2025

(30) Foreign Application Priority Data
Mar. 1, 2023 (EP) 23159293.2

(51) Int. Cl. C01B 3/34; C10K 3/02

(52) U.S. Cl. CPC C01B 3/34; C10K 3/026; C01B 2203/0216; C01B 2203/0405; C01B 2203/085; C01B 2203/1241

(57) ABSTRACT

Syngas is produced from hydrocarbons and carbon dioxide. A steam methane reformer is configured to receive a hydrocarbon containing stream and steam, and to produce a first intermediate syngas stream from the hydrocarbon containing stream and the steam. At least a fraction of the hydrogen produced in the steam methane reformer is removed from the first intermediate syngas stream, and fed to a reverse water gas shift reactor in which carbon dioxide is reverse shifted to CO. The resulting CO-containing effluent stream is combined with a second intermediate syngas stream, which is a residue stream from the first intermediate syngas stream from which the fraction of hydrogen has been removed. Unconverted hydrogen which is discharged from the reverse water gas shift reactor, can be reintroduced in the second intermediate syngas stream together with the CO. The combined stream is a final syngas stream.

### FIELD OF THE INVENTION

In one aspect the invention relates to a system for producing syngas. In another aspect, the invention relates to a method of producing syngas.

### BACKGROUND TO THE INVENTION

Syngas, short for synthesis gas, is a mixture of hydrogen (H₂) and carbon monoxide (CO). The gas often contains some amounts of other molecules, such as carbon dioxide (CO₂) and/or methane (CH₄). It may be used as feedstock to produce hydrocarbons, such as methanol, or as feedstock for other processes, including for example Fischer-Tropsch processes. The optimal ratio between H₂ and CO in the syngas is determined by the subsequent process or use of the syngas, and it is desirable to control the ratio to this optimal ratio.

Syngas that is rich in H₂ is typically produced by steam reforming of natural gas and/or liquid hydrocarbons. This requires a significant amount of energy, as the reactions involved are endothermic. It has also been suggested to use waste and/or biomass and related hydrocarbon feedstocks to generate biogas and biochar in waste-to-energy gasification facilities. It would be desirable to convert the (bio-)gas generated (mostly methane and carbon dioxide) into syngas. However, varying amounts of CO₂ in the feed gas may be problematic.

WO 2022/079098 A1 describes a plant, which consists of a syngas stage for syngas generation and a synthesis stage where the syngas is synthesized to produce a syngas derived product. The syngas stage can comprise a reverse water gas shift (RWGS) section in parallel to a steam methane reforming (SMR) section. Feed streams of hydrogen and carbon dioxide are directed to the RWGS section. Feed streams of hydrocarbons and steam are directed to the SMR section. The syngas component from the SMR section and the product from the RWGS section are combined at the syngas stage and the combined syngas stream is directed to the synthesis stage. The plant may comprise a hydrogen removal section, located between the syngas stage and the synthesis stage. At least a portion of the hydrogen removed from the combined syngas stream in this hydrogen removal section may be compressed and recycled to the RWGS section.

### SUMMARY OF THE INVENTION

In accordance with one aspect of the present invention, there is provided a method of producing syngas from hydrocarbons and carbon dioxide, said method comprising:
subjecting a CO₂ containing stream to a reverse water gas shift reaction with hydrogen, whereby producing CO and water;
subjecting a hydrocarbon containing stream, together with steam, to a steam methane reforming reaction, whereby producing a first intermediate syngas stream;
removing a fraction of hydrogen from the first intermediate syngas stream and whereby a residual of the first intermediate syngas stream, from which said fraction is removed, is a second intermediate syngas stream;
adding at least the CO produced by the reverse water gas shift reaction to the second intermediate syngas stream, thereby obtaining a final syngas stream having a target stochiometric ratio of H₂:CO; and
feeding the fraction of hydrogen to the reverse water gas shift reaction.

In another aspect of the invention, there is provided a system for producing syngas from hydrocarbons and carbon dioxide, said system comprising:
a reverse water gas shift reactor configured to receive a CO₂ containing stream and hydrogen, and to produce a CO-containing stream and water;
a steam methane reformer configured to receive a hydrocarbon containing stream and steam, and to produce a first intermediate syngas stream;
a hydrogen separation unit configured to receive said first intermediate syngas stream and to remove a fraction of hydrogen from the intermediate syngas and to provide a second intermediate syngas stream;
a combiner configured to add the CO-containing stream to the second intermediate syngas stream and thereby to obtain a final syngas stream; and
a hydrogen line configured to pass the fraction of hydrogen from the hydrogen separation unit to the reverse water gas shift reactor.

### BRIEF DESCRIPTION OF THE DRAWINGS

The drawing figures depict one or more implementations in accordance with the present teachings, by way of example only, not by way of limitation. In the figures, like reference numerals refer to the same or similar elements.

FIG. 1 shows a schematic process flow diagram illustrating an example of a system and method for producing syngas from hydrocarbons and carbon dioxide;

FIG. 2 shows a schematic process flow diagram of a preferred embodiment of the system and method illustrated in FIG. 1; and

FIG. 3 shows a schematic process flow diagram of another preferred embodiment of the system and method illustrated in FIG. 1.

The drawings figures are schematic and focused on the inventive features of the present application. As such, certain detailed engineering features as compressors and valves have been omitted from the drawings.

### DETAILED DESCRIPTION OF THE INVENTION

The person skilled in the art will readily understand that, while the detailed description of the invention will be illustrated making reference to one or more embodiments, each having specific combinations of features and measures, many of those features and measures can be equally or similarly applied independently in other embodiments or combinations.

The present disclosure provides a system and method for producing syngas from hydrocarbons and carbon dioxide. A steam methane reformer is configured to receive a hydrocarbon containing stream and steam, and to produce a first intermediate syngas stream from the hydrocarbon containing stream and the steam.

As steam methane reforming may produce syngas with a H₂:CO ratio in excess of a desired target, at least a fraction of the hydrogen produced in the steam methane reformer is removed from the first intermediate syngas stream, and fed to a reverse water gas shift reactor where it is employed to drive a water gas shift reaction as much as possible to the CO and water side of the shift reaction in order to convert as much carbon dioxide as possible. The CO-containing effluent stream from the reverse water gas shift reactor is combined with a second intermediate syngas stream, which is a residue stream from the first intermediate syngas stream from which the fraction of hydrogen has been removed.

Unconverted hydrogen which is discharged from the reverse water gas shift reactor, can be reintroduced in the second intermediate syngas stream together with the CO. The combined stream is a final syngas stream which can have the desired target H₂:CO ratio.

Herewith is provided a system and method in which hydrogen produced by the steam methane reformer is employed to assist the reverse shift from CO₂ to CO in the reverse water gas shift reactor. This allows for reverse shifting more CO₂ to CO. Yet, a hydrogen recycle stream of hydrogen from the reverse water gas shift reaction is avoided, by removing hydrogen from the first intermediate syngas stream before combining it with the CO containing stream from the reverse water shift reactor. This essentially makes it a single pass process, which is generally more efficient than a multiple pass process wherein a part of the process stream passes a certain unit multiple times. Notwithstanding, although the Applicant sees an opportunity to avoid this particular recycle stream of hydrogen, the Applicant does not necessarily exclude the possibility that one or more other recycle streams may optionally be employed in the processes, including recycle streams obtained from a downstream synthesis process.

Other advantages include that less gas flow is passed through the hydrogen removal unit, which generally means that it can be dimensioned smaller, leading to capital expenditure reduction. Moreover, the hydrogen is removed from a stream that is richer in hydrogen than it would have been if the hydrogen were, for example, removed from the combined stream produced by the steam methane reformer and the reverse water gas shift reaction. The higher hydrogen partial pressure leads to a relatively higher hydrogen flux from a pressure-driven hydrogen separation membrane.

Advantageously, the steam methane reformer is employed to generate as much hydrogen as possible, which can be much more than required for the ultimate target stochiometric ratio of H₂:CO. This in part drives the choice to use steam methane reforming. The hydrogen can be depleted from the first intermediate syngas stream as much as desired, as hydrogen that is not converted in the reverse gas shift reactor will be passed back to the syngas stream.

The ultimate stochiometric ratio of the final syngas stream can be accurately tuned and controlled by controlling the amount of excess hydrogen relative to the carbon dioxide being fed to the reverse water shift reaction.

Both the SMR and the RWGS reactions are endothermic. Advantageously, one, or both, of the SMR and RWGS reactor may be electrically heated to avoid generation of CO₂ for heating. In such a case, the SMR and/or RWGS reactor may comprise electric heating elements, such as resistive and/or radiative heating elements fed by electric power. The electric power for said heating is preferably acquired from one or more renewable sources, such as solar power, wind power, or hydraulic power.

The hydrocarbon containing stream may be referred to as a hydrocarbon rich stream. Typically, hydrocarbons make up more than 50 mol. % of the hydrocarbon containing stream. Preferably, hydrocarbons make up more than 75 mol. % of the hydrocarbon containing stream. The term mol. % signifies percentage of specific molecules (in this case, hydrocarbon) relative to all molecules in the hydrocarbon containing stream. The hydrocarbon containing stream may suitably contain light hydrocarbons such as methane and/or ethane and/or propane.

The CO₂ containing stream may be referred to as a hydrocarbon rich stream. Typically, CO₂ makes up more than 50 mol. % of the CO₂ containing stream. Preferably, CO₂ makes up more than 75 mol. % of the CO₂ containing stream. The term mol. % signifies percentage of CO₂ molecules (in this case, hydrocarbon) relative to all molecules in the CO₂ containing stream.

The proposed system and method can be advantageously employed to convert a CO2 containing hydrocarbon stream into synthesis gas of a desired stochiometric ratio. A typical source of such CO₂-containing hydrocarbon stream is renewable natural gas, such as gas derived from biomass. Certain off gas streams from other processing can also be used. In such instances, a feed stream comprising a mixture of hydrocarbons and carbon dioxide could optionally first be subjected to separating at least a part of the feed stream, into a CO₂-containing stream and a hydrocarbon containing stream. The CO₂-containing stream may then be directed to the reverse water gas shift reactor, while the hydrocarbon containing stream is directed to the methane steam reformer. Such removal step may increase the production of hydrogen in the methane steam reformer.

Alternatively, a CO₂ separator is provided in the final syngas stream. Such CO₂ separator in the final syngas stream may be provided instead of such separator in the feed stream, or in addition to such separator in the feed stream. The preferred option may be to include such CO₂ separator in the final syngas stream and not in the hydrocarbon containing feed stream. The advantage of providing the CO₂ separator in the final syngas stream is that a lower CO₂ level in the syngas stream can be achieved than with only a CO₂ separator in the hydrocarbon containing feed stream, as a CO₂ separator in the final syngas stream may also remove at least parts of the CO₂ that may be produced in the steam methane reformer as by-product and/or unreacted CO₂ from the reverse water gas shift reaction. However, if the level of CO₂ in the final syngas stream is less of a concern (depending on the type of downstream use of the final syngas that is being produced), then it may be more advantageous to include the CO₂ separator in the hydrocarbon-rich feed stream to reduce the CO₂ loading of the steam methane reformer.

FIG. 1 illustrates a system for producing syngas from hydrocarbons and carbon dioxide in accordance with the invention. The system comprises a steam methane reformer (SMR) 10 and a reverse water gas shift (RWGS) reactor 20 and a hydrogen separation unit (HSU) 30.

The SMR reaction is well known in the industry. The SMR 10 is configured to receive a hydrocarbon containing stream 12 and steam 14, and it is configured to produce a first intermediate syngas stream 15. The hydrocarbon containing stream 12 may suitably be fed to the SMR 10 via a hydrocarbon feed line. The hydrocarbon containing stream 12 may suitably comprise methane (CH₄). For example, hydrocarbon containing stream 12 may be a pure methane stream, or in other examples at least 10 mol. % or at least 50 mol. % may comprise of methane. Other hydrocarbons may be present in the hydrocarbon containing stream 12, particularly ethane, as well as some non-hydrocarbon contaminants (such as CO₂, nitrogen, inerts, for example). Although the hydrocarbon containing stream 12 and steam 14 are depicted in separate lines in FIG. 1, it will be understood that both components may be fed to the SMR 10 via a single combined line (not shown). Moreover, the hydrocarbon containing stream 12 may comprise non-hydrocarbon contaminants such as CO₂ in addition to hydrocarbons. The first intermediate syngas stream 15 typically contains a mixture of CO and H₂ as well as some unreacted constituents such as water H₂O and potential non-hydrocarbon contaminants such as CO₂. The water may optionally be knocked out from the first intermediate syngas stream 15 prior to feeding the first intermediate syngas stream 15 to the HSU 30. Such knocked-out water may optionally be led to a water treatment unit, for example.

The HSU 30 is configured to remove a fraction of hydrogen from the first intermediate syngas stream 15 and to provide a second intermediate syngas stream 35. The second intermediate syngas stream 35 essentially is the residual stream of the first intermediate syngas stream 15 from which the fraction of hydrogen has been removed.

The fraction of hydrogen is discharged from the HSU 30 in hydrogen line 34. The hydrogen line 34 is configured to pass the fraction of hydrogen from the HSU 30 to the RWGS reactor 20. Optionally, additional hydrogen, from an external source, may be fed to the RWGS reactor 20.

The HSU 30 may include a membrane separator, such as a pressure-driven membrane and/or electrolytic proton-conducting membrane. The latter is driven by an electric field applied over the membrane, which has as advantage that the hydrogen does not have to be (re-)compressed prior to feeding to the RWGS reactor 20. A further advantage of the latter, is that the hydrogen can be removed from the first intermediate syngas stream 15 to much lower levels than what is generally achievable by pressure-driven membranes. Examples of suitable electric field driven membranes and H₂ separation and compression using proton ceramic electrochemical reactors to extract pure H₂ from gas mixtures by electrolytically pumping protons across the membrane are provided in scientific literature. For example, reference is made to: S. H. Morejudo et al., Science Vol. 353, pages 563-566 and references 9-12 therein; Kreuer, Solid State Ionics Vol. 125, pages 285-302 (1999); and Clark et al., Science Vol. 376, pages 390-393 (2022).

The RWGS reactor 20 is configured to receive a CO₂ containing stream 22 and least the hydrogen from hydrogen line 34, and it is configured to produce a CO-containing stream 25. Although the CO₂ containing stream 22 and the hydrogen line 34 are as shown as separate feed lines into the RWGS reactor 20, it will be understood that both components may be fed to the RWGS reactor 20 via a single combined line (not shown). The CO-containing stream 25 contains CO and water produced by the RWGS reaction. In addition to CO and water, the RWGS reactor 20 also discharges unreacted CO₂ and H₂ in the CO-containing stream 25. A combiner 26 is arranged in CO-containing stream 25 and the second intermediate syngas stream 35, wherein both streams are mixed to provide a final syngas stream 28. Especially the water may optionally be knocked out from the CO-containing stream 25 between the RWGS reactor 20 and the combiner 26. Such knocked-out water may optionally be led to the water treatment unit, for example.

The SMR 10 and/or the RWGS reactor 20 in the system described herein can be heated in any known way, including fuel firing and electric heating. When the latter is employed, the system is in essence a converter of electric power into chemical feedstock which absorbs CO₂. The electric power for said heating is preferably acquired from one or more renewable sources 100, such as solar power, wind power, or hydraulic power.

Optionally, a power storage capability is available, in addition to the one or more renewable sources 100, to supply power during periods where renewable generation is lower. Optionally, electric power to drive the HSU 30 may be obtained from renewable sources 100 as well.

The final syngas stream 28 is typically intended to be employed as synthesis feed stream to a synthesis process 40, such as a Fischer-Tropsch synthesis or any other heavy paraffin synthesis or methanol synthesis process. Such synthesis process 40 is associated with an optimum stoichiometric ratio (mole-ratio) of H₂:CO in the synthesis feed stream, which in case of heavy paraffin synthesis is often around 2:1. Generally, an SMR process applied to methane (CH₄), as the hydrocarbon containing stream, can yield much higher ratios exceeding 2.2:1. By removing the fraction of H₂ from the first intermediate syngas stream 15, the stochiometric ratio is reduced. The stoichiometric ratio of the final syngas stream 28 is further influenced by the stoichiometric ratio of the CO-containing stream 25, and the relative volumetric flow rates of the CO-containing stream 25 and second intermediate syngas stream 35 in combiner 26. These degrees of freedom offer amply opportunities to tune the stoichiometric ratio of the final syngas stream 28 to a desired target stochiometric ratio of H₂:CO. The target stochiometric ratio of H₂:CO may be implied by the downstream synthesis process 40, and for many applications it will be between 1.9 and 2.2, or more precisely, between 2.0 and 2.2, depending on the synthesis process requirements for products like paraffines or methanol.

In fact, so much H₂ may be removed from the first intermediate syngas stream that the stochiometric ratio of H₂:CO in the second intermediate syngas stream 35 is lower than the target stochiometric ratio. This way, more hydrogen will be available for the RWGS reaction to drive the reaction equilibrium more to the CO side of the shift reaction. Any unconverted hydrogen from the RWGS reaction will be comprised in the CO-containing stream 25, and returned to the final syngas stream 28 via the combiner 26 (together with the at least the CO produced by the RWGS reaction).

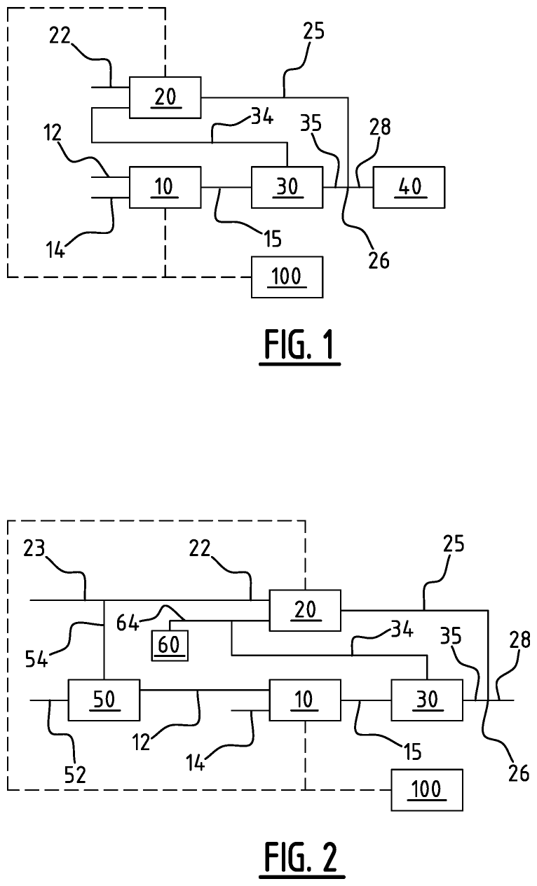

FIG. 2 shows a preferred embodiment of the system and method illustrated in FIG. 1. The system and method of FIG. 1 may be supplemented with a number of additional features which may optionally be added to the system and method individually or jointly.

One of the optional additional features comprises a CO₂ separator 50, that is configured to receive a raw feed stream 52, and to separate CO₂ from at least a part of the raw feed stream 52. A CO₂ feed line 54 is provided to supply the CO₂-containing stream 22 with the CO₂ separated from the raw feed stream 52. The CO₂ separator 50 is also connected to the hydrocarbon feed line to supply the hydrocarbon containing stream 12 with hydrocarbons from the CO₂ separator 50. Herewith, it may be possible to accept hydrocarbon streams which contains more than a certain amount of CO₂ as feed to an SMR process. Accordingly, a broader range of hydrocarbon containing feed sources can be accepted and processed, including for example renewable natural gas sources, such as bio gas or off-gas from other processes. The excess H₂ produced in the SMR 10 is then advantageously used to produce additional CO out of the CO₂ from the raw feed stream 52. Optionally, particularly when there is sufficient H₂ available, additional CO₂ from an external CO₂ source may be fed to the RWGS reactor 20, suitably via a CO₂ feed line 23. The CO₂ feed line 23, which connects the external CO₂ source to the RWGS reactor 20, bypasses the CO₂ separator 50.

Another of the optional additional features comprises a H₂ producer, such as an electroly zer 60 configured to split water into O₂ and H₂ by electrolysis. H₂ produced by the H₂ producer may be fed to the RWGS reactor 20, e.g. via line 64, to shift more CO₂ into CO. Line 64 may be combined with hydrogen line 34 and/or the CO₂ containing stream 22 and/or fed to the RWGS reactor 20 via a separate port. The electrolyzer 60 provides another opportunity to consume renewable power and transform it into synthesis gas.

Process water, such as water from the RWGS reaction or residual water from the SMR, may be cycled back into the synthesis gas process, to make more hydrogen available to convert CO₂ into CO. For example, it may be passed to the SMR, where the hydrogen is obtained thermally (electro-thermally, to the extent in which the SMR is electrically heated) and/or it may be passed to the electroly zer where the hydrogen is obtained electrochemically. Water from the RWGS reaction may be knocked out from the CO-containing stream 25, by means of a water removal unit downstream of the RWGS reactor 20 and preferably upstream of the combiner 26. Residual water from the SMR may be knocked out prior to the HSU. Wastewater from the synthesis process 40 may also be cycled back to synthesis gas process. Any process water or wastewater may first be passed through a water treatment unit, such as an anaerobic water treatment unit (not shown in the figures). Water may also be imported from an external source.

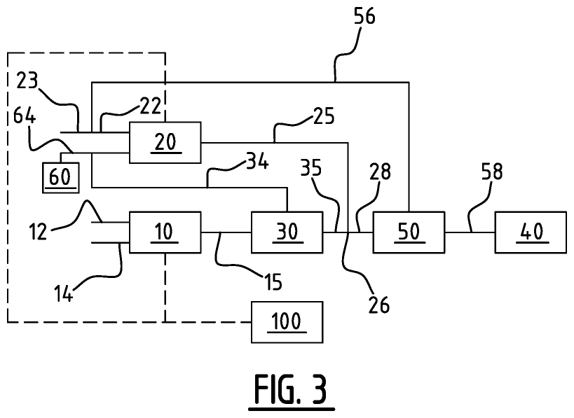

FIG. 3 shows an alternative embodiment of the system and method illustrated in FIG. 2. In FIG. 2, the CO₂ separator 50 is provided as a feed stream CO₂ separator configured to separate CO₂ from at least part of the raw feed stream 52 and provide it to the RWGS reactor 20. The embodiment of FIG. 3 also has a CO₂ separator 50 configured to provide CO₂ to the RWGS reactor 20, but in this case the CO₂ separator 50 is provided as a downstream CO₂ separator configured to receive at least part of the final syngas stream 28 from the combiner 26, and to separate CO₂ from the final syngas stream 28. A CO₂ recycle line 56 is provided between the CO₂ separator 50 and the RWGS reactor 20 to supply the CO₂-containing stream 22 with CO₂ separated from the final syngas stream 28. The remaining part of the final syngas stream may be discharged through outlet line 58, to the synthesis process 40, for example. Also in this embodiment, additional CO₂ from an external CO₂ source may optionally be fed to the RWGS reactor 20, for example via CO₂ feed line 23.

It is also a possibility to combine both options shown in FIGS. 2 and 3, by providing both the feed stream CO₂ separator and the downstream CO₂ separator. In addition, CO₂ from an external CO₂ source may optionally be fed to the RWGS reactor 20.

The synthesis process 40 may further be integrated with the system and method described herein by feeding an off-gas from the synthesis process 40 to the SMR 10.

Depending on the content of the off-gas, a hydrogenation step may be applied to the off-gas. Hydrogen for the hydrogenation step may be obtained from the H₂ producer described above, if such H₂ producer is provided. The (hydrogenated) off-gas may be passed to the SMR 10. Pure CO₂ streams or certain other CO₂ containing streams from synthesis process 40 may, alternatively, be passed to the RWGS reactor 20.

Other equipment, such as compressors and pumps, may also be powered electrically, preferably from one or more renewable sources.

The person skilled in the art will understand that the present invention can be carried out in many various ways without departing from the scope of the appended claims.

1. A method of producing syngas from hydrocarbons and carbon dioxide, said method comprising:
subjecting a CO₂ containing stream to a reverse water gas shift reaction with hydrogen, whereby producing CO and water;
subjecting a hydrocarbon containing stream, together with steam, to a steam methane reforming reaction, whereby producing a first intermediate syngas stream;
removing a fraction of hydrogen from the first intermediate syngas stream and whereby a residual of the first intermediate syngas stream, from which said fraction is removed, is a second intermediate syngas stream;
adding at least the CO produced by the reverse water gas shift reaction to the second intermediate syngas stream, thereby obtaining a final syngas stream having a target stochiometric ratio of H₂:CO; and
feeding the fraction of hydrogen to the reverse water gas shift reaction.

2. The method of claim 1, further introducing additional hydrogen from an alternate source, such as electrolysis of water, and feeding the additional hydrogen to the reverse water gas shift reaction.

3. The method of claim 2, wherein electricity for the electrolysis comprises electricity acquired from one or more renewable sources.

4. The method of claim 1, wherein the reverse water gas shift reaction and/or the steam methane reforming reaction are heated by electric heating.

5. The method of claim 5, wherein electricity for said electric heating comprises electricity acquired from one or more renewable sources.

6. The method of claim 1, wherein removing a fraction of hydrogen from the first intermediate syngas stream comprises passing the hydrogen through an electrolytic proton conducting membrane which is driven by an applied electric field.

7. The method of claim 1, further comprising separating CO₂ from at least part of the final syngas stream to supply the CO₂-containing stream with CO₂ separated from at least part of the final syngas stream.

8. The method of claim 1, further comprising
receiving a feed stream comprising a mixture of hydrocarbons and carbon dioxide;
separating CO₂ from at least a part of the feed stream, to supply the CO₂ containing stream with CO₂ separated from the at least the part of the feed stream, and to provide the hydrocarbon containing stream.

9. The method claim 1, wherein the target stochiometric ratio is between 1.9 and 2.2, preferably between 2.0 and 2.2.

10. The method of claim 1, wherein a first mole ratio of H₂:CO in the first intermediate syngas stream is higher than the target stochiometric ratio, and wherein a second mole ratio of H₂:CO in the second intermediate syngas stream is lower than the target stochiometric ratio, and wherein unconverted hydrogen from the reverse water gas shift reaction is returned to the second intermediate syngas stream, together with the at least the CO produced by the reverse water gas shift reaction, to form the final syngas stream.

11. A system for producing syngas from hydrocarbons and carbon dioxide, said system comprising:
a reverse water gas shift reactor configured to receive a CO₂ containing stream and hydrogen, and to produce a CO-containing stream and water;
a steam methane reformer configured to receive a hydrocarbon containing stream and steam, and to produce a first intermediate syngas stream;
a hydrogen separation unit configured to receive said first intermediate syngas stream and to remove a fraction of hydrogen from the first intermediate syngas and to provide a second intermediate syngas stream;
a combiner configured to add the CO-containing stream to the second intermediate syngas stream and thereby to obtain a final syngas stream; and
a hydrogen line configured to pass the fraction of hydrogen from the hydrogen separation unit to the reverse water gas shift reactor.

12. The system of claim 11, wherein the hydrogen separation unit comprises an electrolytic proton conducting membrane.

13. The system of claim 11, further comprising:
a downstream CO₂ separator configured to receive at least part of the final syngas stream from the combiner and to separate CO₂ from the at least part of the final syngas stream, and
a CO₂ recycle line between the downstream CO₂ separator and the reverse water gas shift reactor to supply the CO₂-containing stream with CO₂ separated from the at least part of the final syngas stream.

14. The system of claim 11, further comprising:
a feed stream CO₂ separator configured to separate CO₂ from at least part of a feed stream comprising a mixture of at least hydrocarbons and CO2;
a CO₂ feed line to supply the CO₂-containing stream with CO₂ separated from the at least part of the feed stream; and
and hydrocarbon feed line to supply the hydrocarbon containing stream with hydrocarbons from the feed stream CO₂ separator.

15. The system of claim 11, wherein the steam methane reformer and the reverse water gas shift reactor comprise electric heating elements for providing heat to enable endothermic reactions.
